(19) United States
(12) Patent Application Publication
(10) Pub. No.: US 2013/0033156 A1
(43) Pub. Date: Feb. 7, 2013

(54) Electrical condenser assemblies and magnetos for spark ignition engines

(71) Applicants: Kenneth Stanley TARGETT, Horton Heath (GB); Paul William BROWN, Montmartin-en-Graignes (FR)

(72) Inventors: Kenneth Stanley TARGETT, Horton Heath (GB); Paul William BROWN, Montmartin-en-Graignes (FR)

(21) Appl. No.: 13/564,752

(22) Filed: Aug. 2, 2012

(30) Foreign Application Priority Data
Aug. 3, 2011 (GB) GB1113333.7

(51) Int. Cl. H01G 4/38; H02K 15/00; H02K 11/00

(52) U.S. Cl. 310/70 A; 361/329; 29/825

(57) ABSTRACT

An electrical condenser is disclosed for an automotive ignition system wherein the ignition system has first and second contact breaker points and first and second electrically conductive members electrically connected to the first and second contact breaker points, respectively, the first and second electrically conductive members having first and second faces, respectively, facing each other but not directly electrically connected to each other. The condenser comprises an attachment portion arranged to be interposed between the first and second faces of the electrically conductive members of the ignition system. The attachment portion has first and second oppositely facing electrically conductive faces for making electrical contact with the first and second faces, respectively, of the electrically conductive members of the ignition system. The first and second conductive faces of the attachment portion are not directly electrically connected to each other, but at least one capacitor is electrically connected between them.

### BACKGROUND OF THE INVENTION

This invention relates to electrical condenser assemblies.

The invention was initially conceived as a condenser assembly to deal with problems arising with some types of rotating-coil magneto for spark-ignition engines. However, it also has other applications.

Referring to FIG. 1 of the accompanying drawings, in many designs of rotating-coil magneto of the type fitted to the engines of British and other motorcycles (and other spark-ignition engines) around the middle of the twentieth century, such as the Lucas K1F, K2F and KVF models of magneto and various models by Magneto France, the magneto 10 has a main housing 12 containing a static permanent magnet and a rotating armature 14. The armature 14 has a drive-end casting 16 and a tail-end casting 18 which are mounted in respective ball bearings 20,22 in the housing 12, and the drive-end casting 16 has a drive shaft 24 which projects from the housing 12 and is, in use, driven by the engine on which the main housing 12 is mounted. A laminated core 26 is held between the drive-end and tail-end castings by long screws and spigots and is wound with a pair of windings 28, namely with a low-tension (“LT”) winding, which in turn is over-wound with a high-tension (“HT”) winding. The LT and HT windings have a common end which is grounded to the drive-end casting 16. A contact-breaker (“CB”) assembly 30 is secured to the tail-end casting 18 outside of the main housing 12 and inside a CB housing 32. The CB assembly 30 includes a back plate 34 on which are mounted a fixed live contact point electrically connected to the live end of the LT winding and a movable earth contact point grounded to the CB back plate and, via the tail-end casting and the core and screws, to the drive-end casting. The movable earth contact point is actuated by a ring cam 36 mounted in the CB housing 32. When the CB points are closed, the LT circuit therefore includes an electrical loop through the LT winding and the CB. An HT slip ring 38 is mounted on the tail-end casting 18 and electrically connected to a live end of the HT winding. One or two HT pick-ups 40 engage the slip ring 38. In single or twin cylinder applications, the or each HT pick-up is connected via an HT cable 41 and plug cap to a live terminal of a sparking plug, and the sparking plug is grounded to the engine and thus to the magneto main housing 12 mounted on the engine. In multi-cylinder applications, the HT pick-up(s) is/are connected via a distributor to the engine's sparking plugs. To complete the HT circuit, an earth brush 42 is usually fitted between the main housing 12 and the drive-end casting 16 of the armature 14, and the bearings are electrically insulated from the main housing, so that HT current does not pass through and cause erosion of the bearing races and balls.

In normal operation, the armature 14 is rotated by the engine. During part of each rotation, energy is built up as electrical current in the LT winding (due to the dynamo effect between the permanent magnet and the rotating LT winding). The CB points are then opened by the ring cam 36, whereupon a high voltage is induced across the LT winding (due to the inductance of the LT winding and the reluctance of the LT winding to allow changes of current through it) and an even higher voltage is induced across the HT winding (due to the transformer action between the LT and HT windings) sufficient to cause a spark between the electrodes of the sparking plug for initiating combustion in the engine.

With a magneto as described so far, problems arising when the CB points open, which can cause damage to the magneto and unreliable spark production, are:
(i) The voltages induced across the LT and HT windings may be sufficiently high to cause permanent breakdown of the electrical insulation of the windings. Absent any other effects, when a current flowing through a perfect inductor is instantaneously interrupted by a perfect switch, the voltage self-induced across the inductor is infinite, whatever the inductance value of the inductor (V=L·di/dt). Of course, the windings are not a perfect inductor and CB assembly 30 is not a perfect switch. Nevertheless, the voltages induced can be extremely high. If a breakdown of insulation does occur, it can be permanent, for example due to perforation of an insulator or the formation of a carbon track.
(ii) The voltage induced across the LT winding may be sufficient to cause substantial arcing between the CB points. One effect of this is to slow down the rate of decrease of current through the LT winding (because current continues to flow through the arc) and therefore to reduce the voltages across the LT and HT windings. Another effect is to cause pitting and pimpling of the CB points, and a resultant effect of that is to make the striking of an arc between the CB points even easier. In the event of severe arcing, the heat produced at the CB points may be sufficient to overheat and for example melt surrounding parts of the magneto and/or to weld the CB points together.

To solve these problems, a condenser 44 is connected in parallel with the LT winding and the CB points. (A “condenser” is nowadays more commonly referred to as a “capacitor” in scientific and electrical engineering circles. Nevertheless, the original term “condenser” continues to be more commonly used in automotive engineering circles.) When the CB points are closed, the voltage across the CB points and the condenser 44 is substantially zero. When the CB points open, charging of the condenser 44 by current from the LT winding commences at a finite rate dependent, among other things, on the capacitance of the condenser 44. Also, the voltage at which an arc will strike between the CB points is dependent, among other things, on the distance between the CB points. The capacitance of the condenser 44 is chosen to be sufficiently large that, within the range of running conditions of the magneto 10, when the CB points are open the voltage across the condenser 44 (and therefore between the CB points) is always less than the voltage at which an arc will strike between the CB points (whatever the distance between the CB points). The condenser 44 therefore prevents any substantial arcing between the points, and so the rate of decrease of the current through the LT winding upon opening of the CB points is unaffected by an arc current. However, rate of decrease of the current through the LT winding is now affected by the condenser 44 and is dependent on, among other things, the capacitance of the condenser 44. The condenser 44 acts to reduce the peak LT and HT voltages to levels at which insulation breakdown does not occur and arcing at the CB points is minimal. The condenser 44 also acts with the windings to form a resonant circuit so that the HT voltage oscillates and decays over a significant period of time.

For the models of magneto 10 discussed above, the capacitance value chosen for the condenser 44 is preferably in the range of about 80 to 500 nF (and more preferably in the range of about 100 to 150 nF), and the breakdown voltage of the condenser 44 must be sufficiently high that the condenser 44 can withstand the voltages applied to it. At the time of design of the models of magneto 10 discussed above and with the technology available, the designers chose to use condensers 44 having a paper dielectric, and suitable original condensers 44 had a considerable size (for example 35 mm×30 mm×8 mm) and mass (for example 26 g). It will be noted that, with the LT winding and CB assembly 30 rotating, it is desirable that the condenser 44 is mounted on the armature 14, so as to avoid the need for a slip ring connection (and therefore unwanted electrical resistance and a source of wear) between the condenser 44 and the remainder of the LT circuit. Furthermore, due to the mass of the original condensers 44, it is desirable to mount the condenser 44 with its centre of gravity on the axis of the armature 14. The designers of the magneto models described above chose to mount the condenser 44 centrally in a cavity provided in the drive-end casting 16, the casing of the condenser being soldered to a bracket attached by a pair of screws to the casting 16. The portion of the drive end casting 16 surrounding the cavity usually provides the track 46 for the HT earth brush 42, and therefore such a location for the condenser 44 takes up space which would otherwise be wasted at least to some extent.

Ignition system condensers occasionally break down. Also, condensers having a paper dielectric can be adversely affected by moisture and humidity. Often an engine having a faulty ignition condenser will still run, albeit not particularly well, and it may not be immediately apparent to the operator that the fault lies with the condenser. Continued running of the engine can then cause the problems discussed above, i.e. permanent breakdown of the electrical insulation of the windings and pitting and pimpling of the CB points. With the models of magneto discussed above, the CB points are accessible via an end cover 48 of the CB housing 32 and can therefore be readily inspected and replaced if eroded. However, if a permanent breakdown of the winding insulation occurs, it is necessary for the armature 14 to be rewound, which is a specialist and very expensive operation.

With the location of the condenser 44 in the magneto models discussed above, the condenser 44 is far from being readily accessible or replaceable if the need arises. Removal of the condenser 44 involves: removing the magneto 10 from the engine; removing the end cover 48, the CB assembly 30 and a pair of spark safety screws 50 from the magneto 10; removing the CB housing 32, any shims 52 therefor and the armature 14 from the main housing 12; removing the inner race of the tail-end bearing 22 from the tail-end casting 18 using a special puller; removing some shims 54, a grease flinger 56 and the slip ring 38 in order to obtain access to the heads of the long screws; removing those long screws; partially easing the drive end casting 16 away from the core 26; unsoldering the connections to the condenser 44; completing removal of the drive end casting 16 from the core 26; and then removing the condenser 44 from the drive end casting 16. Replacement involves the opposite steps in reverse order, and additionally the steps of: truing the armature core 26 and end castings 16,18 upon assembly; checking and if necessary adjusting the shimming of the bearings 20,22 on the armature 14 and the shimming between the CB housing 32 and the main housing 12; checking and if necessary adjusting the CB points gap; and re-timing the ignition. Even when the above operations are carried out by a specialist using special tools, it is a time consuming and therefore expensive job, and it is all too easy to cause damage such as cracking of the delicate slip ring 38, breaking of the live end of the HT winding where it is connected to the slip ring 38, and deformation of the drive-end casting 16 and/or armature core 26 when attempting to separate them.

The original types of condenser for the models of magneto discussed above are no longer available, other than occasionally as ‘new old stock’, in which case the condenser may already be faulty before it has even been used depending on the humidity in which it has been stored over the years. When a condenser needs replacing, typically a modern condenser having a paper, plastic film or ceramic dielectric is chosen. Such condensers typically have wire terminations and do not have a casing which can be soldered to the original condenser bracket. One wire of the condenser and the common connection of the LT and HT windings are therefore soldered to a solder tag which is screwed to the drive-end casting, while the other wire of the condenser is soldered to the live end of the LT winding and to a wire which extends through a passageway along the core to the tail end, where it is connected to the live point of the CB assembly. To prevent fracture of the condenser's wires during use, for example due to vibration and/or centrifugal forces, the condenser is preferably potted in resin in the cavity in the drive-end casting. However, should the need ever arise to replace the condenser again, removing the old condenser and its potting resin complicates the replacement procedure.

Wire-ended condensers of the required specification are nowadays available in sizes sufficiently small that the condenser could be disposed at the tail-end of the magneto in an off-centre space on the CB back-plate, with the two wires of the condenser being connected to the live and grounded points. Unless the original condenser at the drive end had become completely out of circuit, it would be necessary to remove the old condenser, or at least disconnect it. However, condenser replacement thereafter might be relatively straightforward and could be carried out as a routine service procedure. However, it would be necessary to secure the body of the condenser to the CB back-plate to prevent the condenser wires breaking due to centrifugal force and/or vibration. This could be done with a special bracket, but there is little space available and it is expected that such a bracket would prove fiddly. Alternatively, the condenser could be glued to the back-plate, but then removal of the condenser might prove difficult, especially if it were desired to re-use the condenser. Depending on where the condenser were sited, it may be important to be able to remove the condenser temporarily, for example to permit adjustment of the CB points gap and/or replacement of the CB points, before replacing the condenser.

In addition to potentially causing permanent damage to the magneto, another effect of running an engine with a faulty ignition condenser is that the efficiency of the engine is decreased so that fuel is wasted and the engine becomes less environmentally friendly.

### SUMMARY OF THE INVENTION

An aim of the present invention, or at least of specific embodiments of it, is to provide a magneto condenser assembly of simple and inexpensive manufacture and which can be readily fitted, removed and replaced. As a result, it is expected that the condenser assembly will be replaced as soon as a potential problem becomes apparent and/or as a regular service item, so that the magneto can function properly and fuel is not wasted.

In accordance with a first aspect of the present invention, there is provided an electrical condenser assembly for an automotive ignition system wherein the ignition system has first and second contact breaker points and first and second electrically conductive members electrically connected to the first and second contact breaker points, respectively, the first and second electrically conductive members having first and second faces, respectively, facing each other but not directly electrically connected to each other. The condenser assembly comprises an attachment portion arranged to be interposed between such first and second faces of such electrically conductive members of such an ignition system, the attachment portion having first and second oppositely facing electrically conductive faces for making electrical contact with the first and second faces, respectively, of the electrically conductive members of the ignition system, the first and second conductive faces of the attachment portion not being directly electrically connected to each other. The condenser assembly furthermore comprises at least one capacitor electrically connected between the first and second conductive faces of the attachment portion.

The attachment portion of the condenser assembly can therefore simply be clamped between two existing parts of the ignition system so as to hold the condenser assembly in place and electrically connect it to the reminder of the ignition system.

The attachment portion preferably has a hole extending therethrough so that said first and second members of the ignition system can be mechanically connected through the hole, or so that one of said first and second members of the ignition system can pass through the hole, for example using an existing component such as a securing screw of the ignition system.

In one embodiment of the invention, the first and second faces of the of the attachment portion are provided by first and second substantially-coaxial, spaced-apart, annular members (for example brass or copper washers) each having a respective hole therethrough, the or each capacitor being disposed between the annular members, but with a passageway extending through the condenser assembly including through the holes of the annular members.

In the original CB assemblies of the Lucas K1F, K2F and KVF models of magneto described above, a mounting block for the fixed CB point is secured to the CB back plate by a 6BA screw extending through the fixed point mounting block into the back plate. The mounting block needs to be electrically insulated from the back plate, and therefore an insulating washer is placed under the head of the screw, and an insulating sleeve lines the hole through the mounting block. That insulating washer can therefore simply be replaced with the annular embodiment of condenser assembly (using a slightly longer screw if necessary). In this case, the first and second faces of the first and second members of the ignition system (as defined in the main statement of the first aspect of the invention) are therefore provided by the top face of the fixed point mounting block and the underside of the head of the 6BA screw (or a washer under the head of the screw).

There may be a plurality of such capacitors arranged around the axis of the annular members, so that, especially if each capacitor has a generally cuboidal package, effective use can be made of the space available, and furthermore so that the compression force applied to the capacitors by the screw can be more evenly distributed. Interstices between the capacitors and around the passageway may be filled with an electrically insulating material, which can assist in holding the capacitors in place and also bear some of the compression force applied to the condenser assembly by the screw.

The or each capacitor preferably has a generally cuboidal package with terminals at a pair of opposed ends of the package, and with each terminal facing and being electrically connected to a respective one of the annular members. Modern surface-mount capacitors may therefore be employed. Such capacitors of the multi-layer ceramic variety are available with capacitances (alone or in parallel combination) and voltage ratings which are suitable for use in ignition systems. They are inexpensive and are incredibly small in size when compared to the sizes of the condensers originally fitted to the models of magneto discussed above.

In another embodiment of the invention, the attachment portion is provided by a region of board having a substrate of electrically insulating material sandwiched between first and second outer layers of electrically conductive material, and the first and second layers of electrically conductive material provide the first and second electrically conductive faces, respectively, of the attachment portion. For example, the attachment portion can be provided by a piece of copper clad board of the type used in the manufacture of printed circuit boards (“PCBs”).

In the original CB assemblies of the Lucas K1F, K2F and KVF models of magneto described above, a small insulating wafer is disposed between the mounting block for the fixed CB point and the CB back plate. That insulating wafer can therefore simply be replaced with the board embodiment of condenser assembly as described above. In this case, the first and second faces of the first and second members of the ignition system (as defined in the main statement of the first aspect of the invention) are therefore provided by the outer face of the CB back plate and the underside of the fixed point mounting block.

Alternatively, the insulating washer under the head of the 6BA securing screw for the fixed-point mounting block may simply be replaced with the board embodiment of condenser assembly. In this case, the first and second faces of the first and second members of the ignition system (as defined in the main statement of the first aspect of the invention) are therefore provided by the top face of the fixed point mounting block and the underside of the head of the 6BA screw (or a washer under the head of the screw).

In later CB assemblies for those models of magneto, two stamped and pressed steel members are secured together by a screw with insulators preventing electrical contact between the two members, including an insulating washer under the head of the screw and an insulating block between the two members. The insulating washer can therefore simply be replaced with the board embodiment of condenser assembly. In this case, the first and second faces of the first and second members of the ignition system (as defined in the main statement of the first aspect of the invention) are the underside of the head of the screw (or a washer under the head of the screw) and the facing portion of the adjacent stamped and pressed steel member. Alternatively, the insulating block may simply be replaced with the board embodiment of condenser assembly. In this case, the first and second faces of the first and second members of the ignition system (as defined in the main statement of the first aspect of the invention) are the facing portions of the two stamped and pressed steel members.

The board preferably also provides at least one capacitor mounting region in which the capacitor(s) is/are mounted. The capacitor or at least one of the capacitors may be electrically connected between first and second portions of one of the layers in that capacitor's mounting region. The first portion of that layer may be contiguous with the portion of that layer in the attachment region, and the second portion of that layer may be electrically connected to the portion of the other layer in the attachment region (for example using conventional PCB viaing techniques), without the first and second portions being directly electrically connected to each other. The first and second areas of the first layer may be separated by a furrow in the board (for example made using conventional PCB etching techniques), with the or each capacitor bridging the furrow. Again, multi-layer ceramic surface-mount capacitor(s) may be used, and may be soldered to the board in a conventional manner.

A second aspect of the invention extends to a magneto having: a low tension coil; a contact breaker assembly having a pair of contact breaker points electrically connected in parallel with the low tension coil; and a condenser assembly according to the first aspect of the invention electrically connected in parallel with the low tension coil and the contact breaker points. In the case where the low tension coil and contact breaker assembly are mounted for rotation with a rotatable armature of the magneto, the condenser assembly is preferably mounted on the contact breaker assembly. As in the known magnetos described above, the armature may be mounted for rotation by a pair of spaced-apart bearings; the low tension coil may be disposed between the bearings; and the contact breaker assembly may mounted at one end of the armature beyond the bearings.

In accordance with a third aspect of the present invention, there is provided a method of modification of a magneto having an armature with a low-tension winding and a condenser electrically connected in parallel with each other and disposed between a drive-end end-piece and a tail-end end-piece of the armature, and a contact breaker assembly mounted on the tail-end end-piece and having first and second contact breaker points electrically connected in parallel with the low-tension winding and first and second electrically conductive members electrically connected to the first and second contact breaker points, respectively, the first and second electrically conductive members having first and second faces, respectively, facing each other but not directly electrically connected to each other. The method comprises the steps of: rendering the condenser substantially ineffective on the low-tension winding; providing a condenser assembly according to the first aspect of the invention; and fitting the condenser assembly to the contact breaker assembly so that the attachment portion is interposed between the first and second faces of the electrically conductive members of the contact breaker assembly, and the first and second faces of the attachment portion make electrical contact with the first and second faces, respectively, of the electrically conductive members of the contact breaker assembly, whereby the capacitor(s) of the condenser assembly is/are electrically connected in parallel with the low-tension winding.

With the embodiments of the invention that have been outlined above and that will now be described, purely by way of example, with reference to the accompanying drawings, once an original condenser that is disposed between the end pieces of the armature has been removed or disconnected, a condenser assembly according to the invention may be simply fitted to the CB assembly at the tail end of the armature without requiring an specialist skills or tools, and thereafter the condenser assembly may be simply replaced as a routine service item, again without requiring an specialist skills or tools.

### BRIEF DESCRIPTION OF THE SEVERAL VIEWS OF THE DRAWING

FIG. 1 is an isometric view of a partially dismantled Lucas model K2F magneto taken from “Lucas Quality Equipment, Volume 2, Workshop Instructions, Motor Cycle Magnetos, Models N1, KN1, K1F, K2F and KVF”, Section L-5 Part A, Issue 1, published by Joseph Lucas Limited in January 1953;

FIGS. 2A-C are a plan view, side view and sectioned side view, respectively, of a back plate of a first known form of CB assembly for the magneto of FIG. 1, the sectioned view of FIG. 2C being taken on the section line 2C-2C shown in FIG. 2A;

FIGS. 3A-C are a plan view, side view and sectioned side view, respectively, of a CB mounting block of the first form of CB assembly, the sectioned view of FIG. 3C being taken on the section line 3C-3C shown in FIG. 3A;

FIGS. 4A-B are a dismantled isometric view and an assembled isometric view, respectively, of the first form of CB assembly (some parts being omitted);

FIGS. 5A-B are a plan view and an underplan view, respectively, of a circuit board for a first embodiment of condenser assembly for use with the first form of CB assembly;

FIGS. 6A-C are a plan view and two sectioned views, respectively and on an enlarged scale, of the first embodiment of condenser assembly, the sectioned views of FIGS. 6B and 6C being taken on the section lines 6B-6B and 6C-6C, respectively, shown in FIG. 6A;

FIGS. 7A-C are a dismantled isometric view, an assembled isometric view and a plan view, respectively, of the first form of CB assembly with the first embodiment of condenser assembly;

FIGS. 8A-C are an exploded isometric view, an unexploded isometric view and a modification thereto, respectively and on an enlarged scale, of a second embodiment of condenser assembly for use with the first form of CB assembly;

FIGS. 9A-B are a partly dismantled isometric view and an assembled isometric view, respectively, of the first form of CB assembly with the second embodiment of condenser assembly;

FIGS. 10A-C sectioned plan views, on an enlarged scale, of the second embodiment of condenser assembly and two further modifications thereto;

FIGS. 11A-B are exploded isometric views, on an enlarged scale and upside down with respect to each other, of a third embodiment of condenser assembly for use with the first form of CB assembly;

FIG. 12 is an isometric view on the enlarged scale of the third embodiment of condenser assembly;

FIGS. 13A-C are a partly dismantled isometric view, an assembled isometric view and a plan view, respectively, of the first form of CB assembly with the third embodiment of condenser assembly;

FIGS. 14A-C are a side view, sectioned side view and a plan view, respectively, of a back plate of a second known form of a CB assembly for the magneto of FIG. 1;

FIGS. 15A-C are a side view, sectioned side view and a plan view, respectively, of a fixed CB point assembly of the second form of CB assembly;

FIGS. 16A-C are a side view, sectioned side view and a plan view, respectively, of a spring anchor bracket of the second form of CB assembly;

FIGS. 17A-B are isometric views showing the top side and the under side, respectively, of an insulating block of the second form of CB assembly;

FIG. 18 is a side view of an assembly screw of the second form of CB assembly;

FIGS. 19A-B are a sectioned side view and a plan view, respectively, of an insulating washer of the second form of CB assembly;

FIGS. 20A-B are a sectioned side view and a plan view, respectively, of an assembly washer of the second form of CB assembly;

FIG. 21 is a side view of a centre screw of the second form of CB assembly;

FIGS. 22A-C are a side view, a sectioned side view and a plan view, respectively, of the second form of CB assembly, with the fixed CB point assembly shown in a centre adjustment position;

FIG. 23 is similar to FIG. 22C, but with the fixed CB point assembly shown at one end of its range of adjustment;

FIGS. 24A-B are a plan view and an underplan view, respectively, of circuit board for a fourth embodiment of condenser assembly for use with the second form of CB assembly;

FIG. 25 is an isometric view of the fourth embodiment of condenser assembly;

FIG. 26A-C are similar to FIGS. 22A-C, respectively, but fitted with the fourth embodiment of condenser assembly; and

FIG. 27 is similar to FIG. 23, but fitted with the fourth embodiment of condenser assembly.

### DETAILED DESCRIPTION OF THE INVENTION

CB Assembly with Brass Back Plate

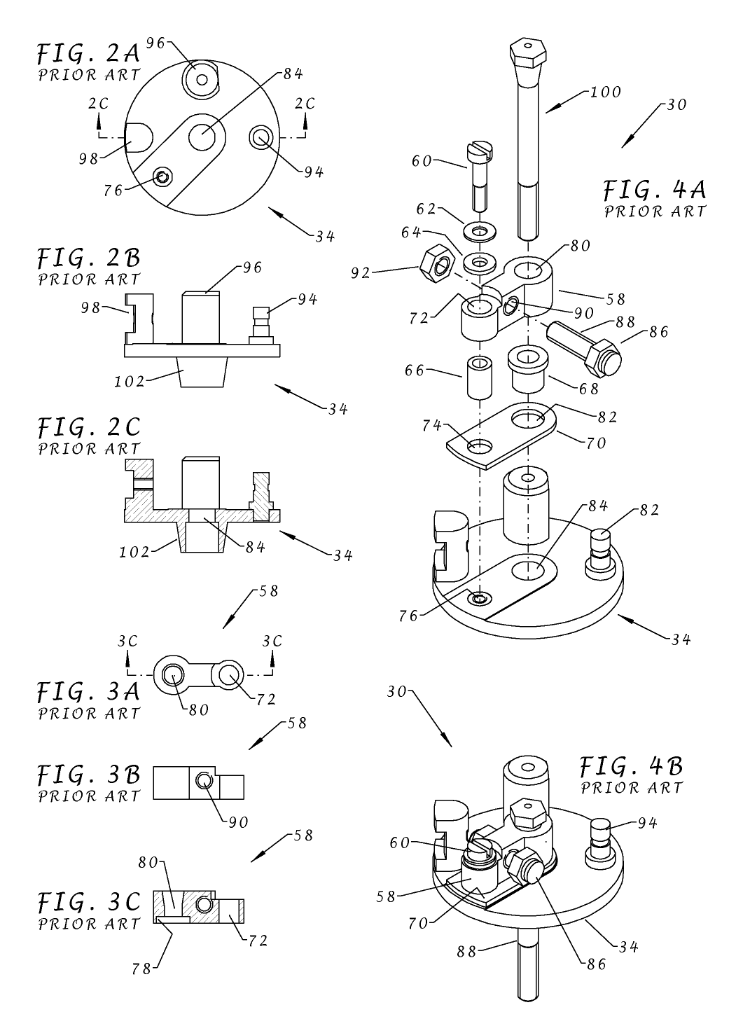

Referring to FIGS. 2A-4B of the drawings, a known early form of CB assembly 30 for the K1F, K2F and KVF models of magneto comprises:
a brass back plate 34.
a brass fixed-point mounting block 58.
a steel screw 60, a brass or steel washer 62, an insulating washer 64, insulating sleeves 66,68 and an insulating wafer 70 for mounting the fixed point mounting block 58 on the back plate 34. The sleeve 66 is disposed in a hole 72 in the fixed-point mounting block 58, and the screw 60 passes through the washers 62,64, the sleeve 66 and a hole 74 in the insulating wafer 70 into a screw-threaded hole 76 in the back plate 34. The sleeve 68 is shouldered externally so as to have a larger diameter portion which is accommodated in a rabbet 78 at the lower end of a further hole 80 in the fixed-point mounting block 58, and a smaller diameter portion which passes through a further hole 82 in the insulating wafer 70 into a central hole 84 through the back plate 34.
a fixed point 86 having a screw-threaded stem 88 which is adjustably secured in a screw-threaded hole 90 in the fixed-point mounting block 58 and locked with a lock nut 92 and spring washer (not shown).
a moving point assembly (not shown) which has a body pivotally mounted on a pivot post 94 of the back plate 34 beneath a retaining spring (not shown) cantilevered from a retaining post 96 of the back plate 34. The moving point assembly has a moving point for making electrical contact with the fixed point 86, a follower heel for engaging with the ring cam 36, and a return leaf spring which extends part way around the periphery of the back plate 34 from the body of the moving point assembly to a spring anchor post 98 of the back plate 38 and serves to urge the moving point towards the fixed point 86 and also to make an electrical connection between the moving point and the back plate 34.
a steel centre screw 100 which passes through the hole 80 in the fixed-point mounting block 58, the insulating sleeve 68 and the central hole 84 in the back plate 34 into engagement with a centre nut (not shown) in the armature so to secure the CB assembly 38 to the tail-end casting 18 of the magneto 10 with a keyed and tapered boss 102 on the underside of the back-plate 34 engaging in a keywayed and tapered hole in the tail-end casting 18 so that the CB assembly 30 rotates with the armature 14 of the magneto 10.

The centre nut for the centre screw 100 is electrically connected to the ‘live’ end of the LT winding, and the tail-end casting 18 is electrically connected to the ‘earth’ end of the LT winding. The fixed point 86 is therefore connected to the live end of the LT winding via the fixed-point mounting block 58 and the centre screw 100, but is electrically insulated from the earth end of the LT winding by the insulating washer 64, the insulating sleeve 66 and the insulating wafer 70. On the other hand, the moving point is connected to the earth end of the LT winding via the return spring and the back plate 34.

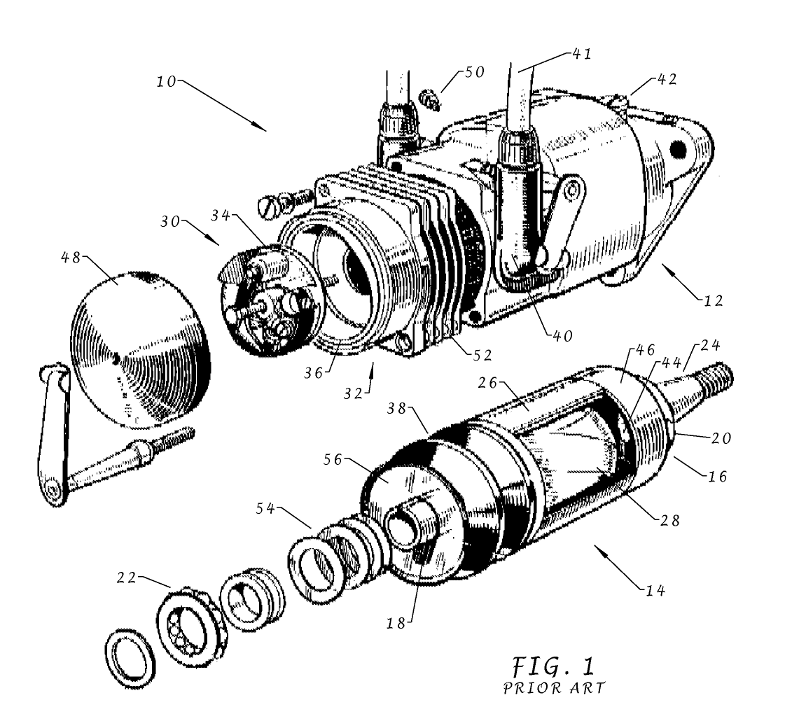

The ring cam 36 (FIG. 1) has two lobes. For each turn of the armature 14, the cam 36 and the heel of the moving point assembly open and close the moving point and the fixed point 86 twice. While the CB points are closed, current builds up in the LT winding due to the dynamo effect between the permanent magnet in the magneto body 12 and the rotating LT winding. When the CB points are then opened, a high voltage is induced across the LT winding.

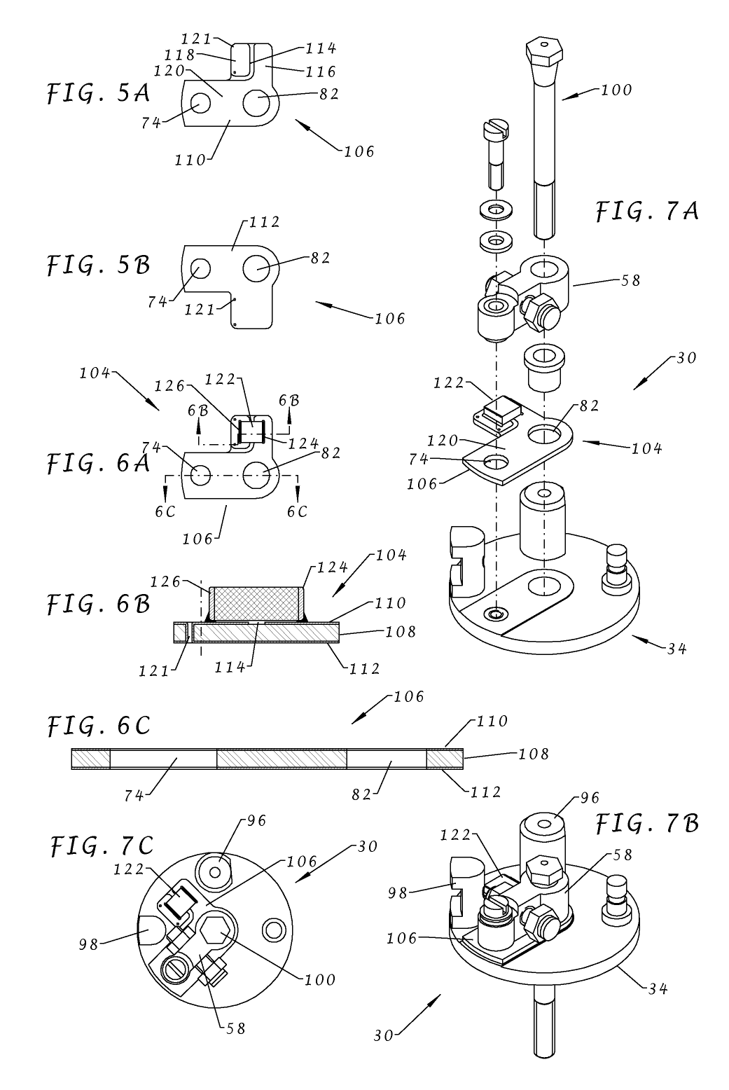

In the original configuration of the magneto 10, the condenser 44 at the drive end of the armature 14 is connected between the ends of the LT winding. When the magneto 10 is converted for use with the first embodiment of the invention, the original condenser 44 is removed from the magneto 10 or electrically disconnected from the LT winding, and the insulating wafer 70 is replaced by a condenser assembly 104 of the first embodiment of the invention, as will now be described with reference to FIGS. 5A-7B.

### First Embodiment of Condenser Assembly

As shown in FIGS. 5A-B and 6B-C, the condenser assembly 104 comprises an L-shaped piece of PCB 106 having a substrate 108 of insulating material sandwiched between first and second outer copper layers 110,112. The longer limb of the L-shape has holes 74,82 corresponding in size and spacing to the holes 74,82 of the insulating wafer 70 described above and shown in FIG. 7A. The first copper layer 110 is etched to form a furrow 114 between first and second portions 116,118 of the copper layer 110 on the shorter limb of the L-shape. The first portion 116 is contiguous with a third portion 120 of the first copper layer 110 on the longer limb of the L-shape. However, the second portion 118 of the first layer 110 is electrically insulated from the remainder of the first layer 110 but is electrically connected to the second copper layer 112 by one or more plated through-holes or vias 121. The PCB 106 may be manufactured using conventional PCB manufacturing techniques.

As shown in FIGS. 6A and 7A-C, the condenser assembly 104 also comprises a capacitor 122 disposed over the shorter limb of the PCB 106 and connected between the first and second portions 116,118 of the first copper layer 110 of the PCB 106. The capacitor 122 is of the multi-layer ceramic type in a surface mount package which is substantially cuboidal and has terminals 124,126 at a pair of opposite faces of the package. The terminals 124,126 are soldered to the PCB 106 using any conventional PCB soldering technique.

As shown in FIGS. 7A-C, the condenser assembly 104 is mounted in the CB assembly 30 in place of the insulating wafer 70 with the second copper layer 112 contacting the back plate 34, with the third portion of the 120 of the first copper layer 110 contacting the fixed-point mounting block 58, and with the shorter limb of the PCB 106 and the capacitor 122 being disposed to one side of the fixed-point mounting block 58 in the space between the retaining post 96 and the anchor post 98. The capacitor 122 therefore becomes electrically connected between the fixed-point mounting block 58 and the back plate 34, and therefore between the fixed and moving points, and, when the CB assembly 30 is assembled with the remainder of the magneto 10, between the ends of the LT winding.

In a prototype of the condenser assembly 104, the insulating substrate 108 of the PCB 106 had a thickness of about 1.00 mm and each copper layer 110,112 had a “weight” of about 2.0 oz/ft² (equivalent to about 0.07 mm per layer), so that the overall thickness of the PCB 106 was about 1.14 mm. The thickness of the original insulating wafer 70 is typically 19 swg (1.016 mm), and so the replacement of the original insulating wafer 70 by the condenser assembly 104 did not cause any substantial misalignment (or substantially better alignment) of the fixed and moving CB points. In the prototype, the capacitor 122 had a nominal capacitance of 150 nF, a voltage rating of 630 V DC, and a package size of 5.7×5.0×2.0 mm, a suitable capacitor 122 being available at the time of writing this specification under the part number GRM55DR72J154 KW01L from Murata Manufacturing Co Ltd of Japan.

### Second Embodiment of Condenser Assembly

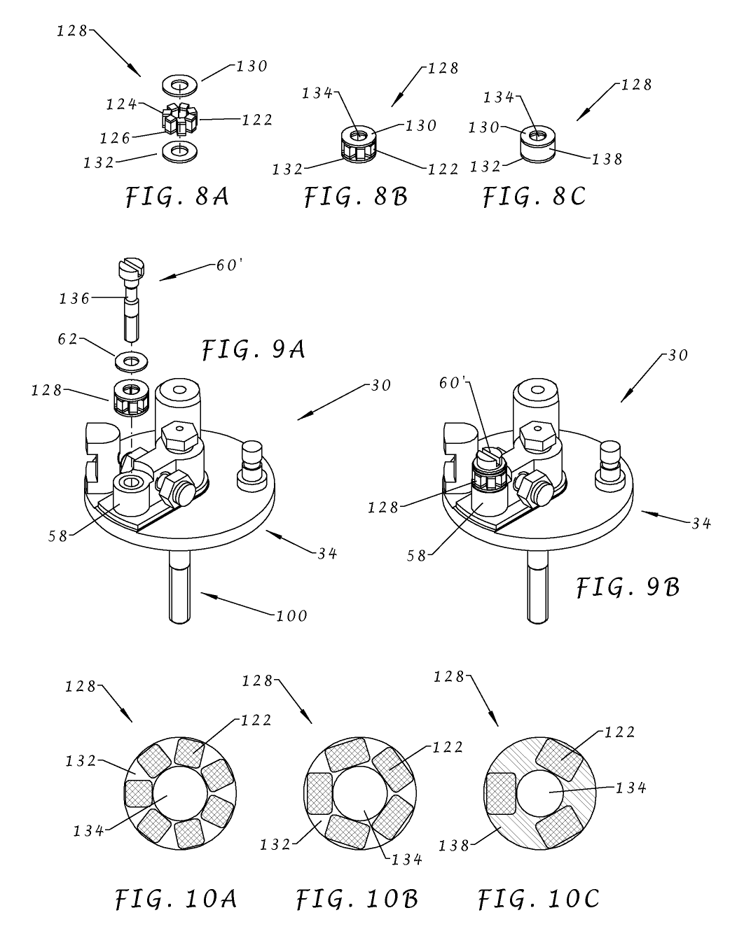

When the magneto 10 is converted for use with the second embodiment of the invention, the original condenser 44 is, as with the first embodiment, removed from the magneto 10 or electrically disconnected from the LT winding, but, instead of replacing the insulating wafer 70 by a condenser assembly 104 of the first embodiment, the insulating washer 64 and screw 60 are replaced by a condenser assembly 128 of the second embodiment of the invention and a modified screw 60′, as will now be described with reference to FIGS. 8A-10C.

As shown in FIGS. 8A-B and 10A, the condenser assembly 128 comprises a close-packed, regular circular array of seven substantially identical capacitors 122 soldered between a pair of standard M3 brass washers 130,132 so that the capacitors 122 are electrically connected in parallel. The capacitors 122 are arranged around a passageway 134 coaxial with the holes through the washers 130,132. Each capacitor 122 is of the multi-layer ceramic type in a surface mount package which is substantially cuboidal and has terminals 124,126 at its upper and lower ends. Each terminal 124,126 faces a respective one of the washers 130,132 and is soldered to it. During manufacture, the abutting surfaces of the washers 130,132 and terminals 124,126 are coated with solder paste. The washers 130,132 and capacitors 122 are then placed in a jig, and heat and slight pressure are applied to the washers sufficient to melt the solder paste and join the washers 130,132 to the respective terminals 124,126.

As shown in FIGS. 9A-B the condenser assembly 128 is mounted in the CB assembly 30 in place of the insulating washer 64 with the screw 60′ passing through the holes in the washers 130,132 and through the passageway 134 around which the capacitors 122 are arranged. The top side of the upper washer 130 contacts the underside of the steel or brass washer 62 beneath the head of the screw 60′, and the underside of the lower washer 132 contacts the fixed-point mounting block 58. As shown in FIG. 9A, the modified screw 60′ is longer than the original screw 60 to take account of the increased thickness of the condenser assembly 128 compared with the original insulating washer 64. Also, the screw 60′ has a waisted portion 136 disposed so that the screw 60′ does not touch the lower washer 132 or the terminals 126 at the lower ends of the capacitors 122. The condenser assembly 128 becomes electrically connected between the fixed-point mounting block 58 and the screw 60′, and therefore between the fixed and moving points, and, when the CB assembly 30 is assembled with the remainder of the magneto 10, between the ends of the LT winding.

In a prototype of the condenser assembly 128 of FIGS. 8A-B and 9A-10A, each washer 130,132 had outside and inside diameters of about 6.8 mm and 3.3 mm respectively. The capacitors 122 each had a nominal capacitance of 15 nF, a voltage rating of 630 V DC, and a package size of 3.2×1.6×1.6 mm, a suitable capacitor 122 being available at the time of writing this specification under the part number GRM31CR72J153 KW03L from Murata Manufacturing Co Ltd of Japan. The nominal overall capacitance of the condenser assembly 128 was therefore 105 nF.

Different numbers and sizes of capacitors 122 may be employed. For example, FIG. 10B shows five capacitors 122 each having a package size of 3.2×2.5×1.5 mm and a nominal capacitance of 22 nF (Murata part number GRM32QR72J223 KW01L) so that the nominal overall capacitance of the condenser assembly 128 is 110 nF. FIG. 10C shows three capacitors 122 each having a package size of 3.2×2.5×2.0 mm and a nominal capacitance of 33 nF (Murata part number GRM32DR72J333 KW01L) so that the nominal overall capacitance of the condenser assembly 128 is 99 nF. In this case, the washers 130,132 have a reduced inside diameter of 2.83 mm, which still provides sufficient clearance for the 6BA screw 60 which has a major diameter of 2.786 mm.

As shown in FIGS. 8C and 10C, the space between the washers 130,132 that is not occupied by the capacitors 122 and the passageway 134 may be filled with an electrically insulating filler material 138, for example of plastics resin, to as to protect the capacitors 122 from their environment and to stiffen the condenser assembly 128 against the compressive force applied by the screw 60′.

### Third Embodiment of Condenser Assembly

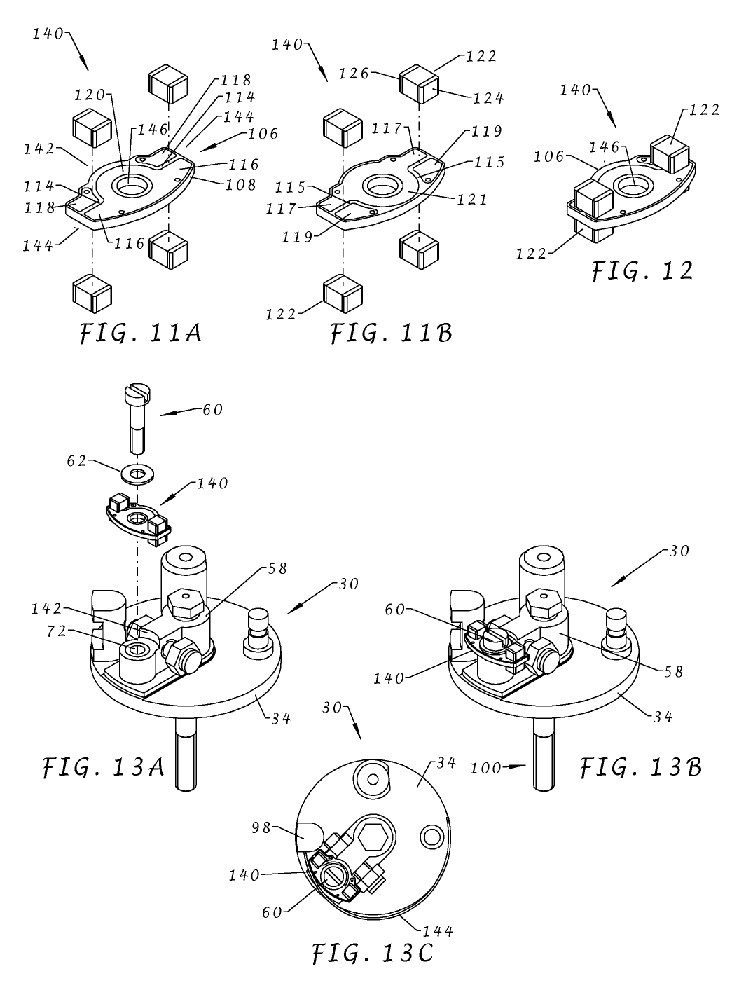

When the magneto 10 is converted for use with the third embodiment of the invention, the original condenser 44 is, as with the first embodiment, removed from the magneto 10 or electrically disconnected from the LT winding, and the insulating washer 64 is replaced by a condenser assembly 140 of the third embodiment of the invention, as will now be described with reference to FIGS. 11A-13C.

As shown in FIGS. 11A-12, the condenser assembly 140 comprises a piece of PCB 106 having a substrate 108 of insulating material sandwiched between first and second outer copper layers. The PCB 106 has a central portion 142 and a pair of wing portions 144, and the central portion has a hole 146 to receive the screw 60. As shown in FIG. 11A, the first copper layer is etched to form furrows 114 between first and second portions 116,118 of the copper layer on each wing portion 144 of the PCB 106. Each first portion 116 is contiguous with a third portion 120 of the first copper layer in the central portion 142 of the PCB 106, but each second portion 118 is isolated therefrom. As shown in FIG. 11B, the second copper layer is etched to form furrows 115 between first and second portions 117,119 of the copper layer on the wing portions 144 of the PCB 106. Each first portion 117 is contiguous with a third portion 121 of the second copper layer in the central portion 142 of the PCB 106, but each second portion 119 is isolated therefrom. The second portions 119 of the second copper layer are beneath the first portions 116 of the first copper layer and are electrically connected thereto by one or more plated through-holes or vias 121. Also, the first portions 117 of the second copper layer are beneath the second portions 118 of the first copper layer and are electrically connected thereto by one or more plated through-holes or vias 123. Therefore, the third portion 120 of the first copper layer is electrically connected to the first portions 116 of the first copper layer and the second portions 119 of the second copper layer, and the third portion 121 of the second copper layer is electrically connected to the first portions 117 of the second copper layer and the second portions 118 of the first copper layer. The PCB 106 may be manufactured using conventional PCB manufacturing techniques.

The condenser assembly 140 also comprises four capacitors 122 disposed over or under the wing portions 144 of the PCB 106 and connected between the first and second portions 116,118; 117,119 of the respective copper layer of the PCB 106. Each capacitor 122 is of the multi-layer ceramic type in a surface mount package which is substantially cuboidal and has terminals 124,126 at a pair of opposite faces of the package. The terminals 124,126 are soldered to the PCB 106 using any conventional PCB soldering technique. The four capacitors 122 therefore become connected in parallel between the third portions 120,121 of the copper layers.

As shown in FIGS. 13A-C, the condenser assembly 140 is mounted in the CB assembly 30 in place of the insulating washer 64 with the third portion 120 of the first copper layer contacting the brass or steel washer 62 under the head of the screw 60 and with the third portion 121 of the second copper layer contacting the fixed-point mounting block 58. The condenser assembly 140 therefore becomes electrically connected between the fixed-point mounting block 58 and the back plate 34, and therefore between the fixed and moving points, and, when the CB assembly 30 is assembled with the remainder of the magneto 10, between the ends of the LT winding.

As can be seen in FIG. 13A, the fixed-point mounting block 58 has a reduced height around the hole 72. The reason for this was possibly so that the screw 60 could have a standard length of ½ inch (12.7 mm). The outline of the PCB 106 is shaped so that it is a snug fit against the riser 142 of the step in the upper surface of the fixed-point mounting block 58. FIG. 13C shows the return leaf spring 144 which extends part way around the periphery of the back plate 34 from the body (not shown) of the moving point assembly to the spring anchor post 98. The outline of the PCB 106 is shaped so that it does not interfere with the return spring 144. As shown in FIGS. 11A-12, the copper layers of the PCB 106 are etched so that they stop short of the outer periphery of the PCB 106 and also stop short of the hole 146 so as to prevent unintentional electrical contact and short-circuiting of the edges of the copper layers with the return spring 144, the fixed-point mounting block 58 or the screw 60. It will be appreciated that the condenser assembly 140 may be fitted either way up.

Each capacitor 122 of the condenser assembly 140 may have a package size of 3.2×2.5× mm and a nominal capacitance of 33 nF (Murata part number GRM32DR72J333 KW01L) so that the nominal overall capacitance of the condenser assembly 140 is 132 nF.

CB Assembly with Steel Back Plate

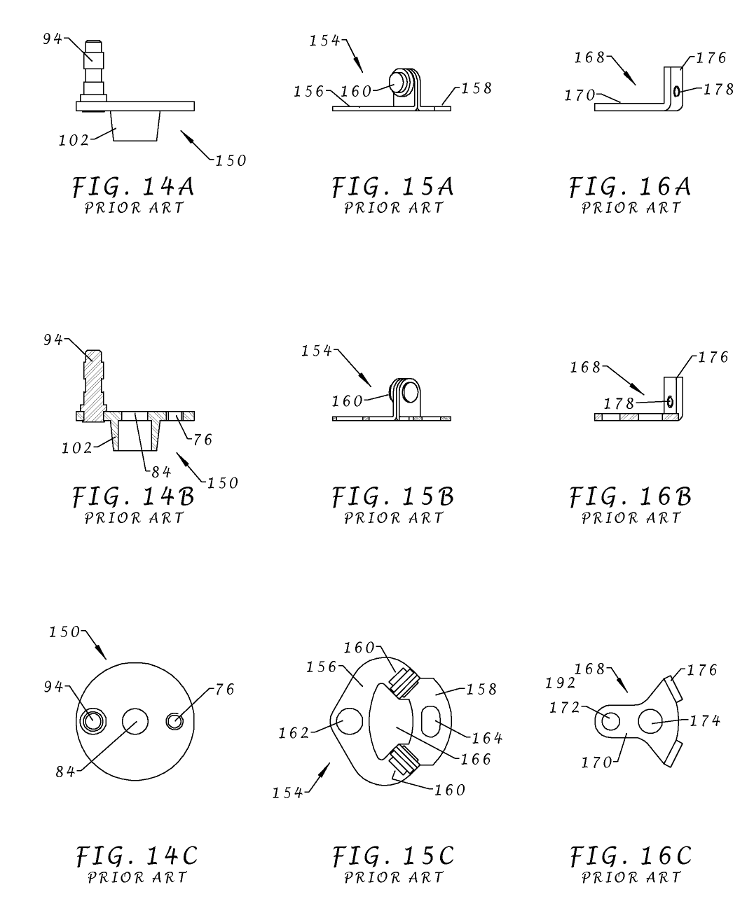

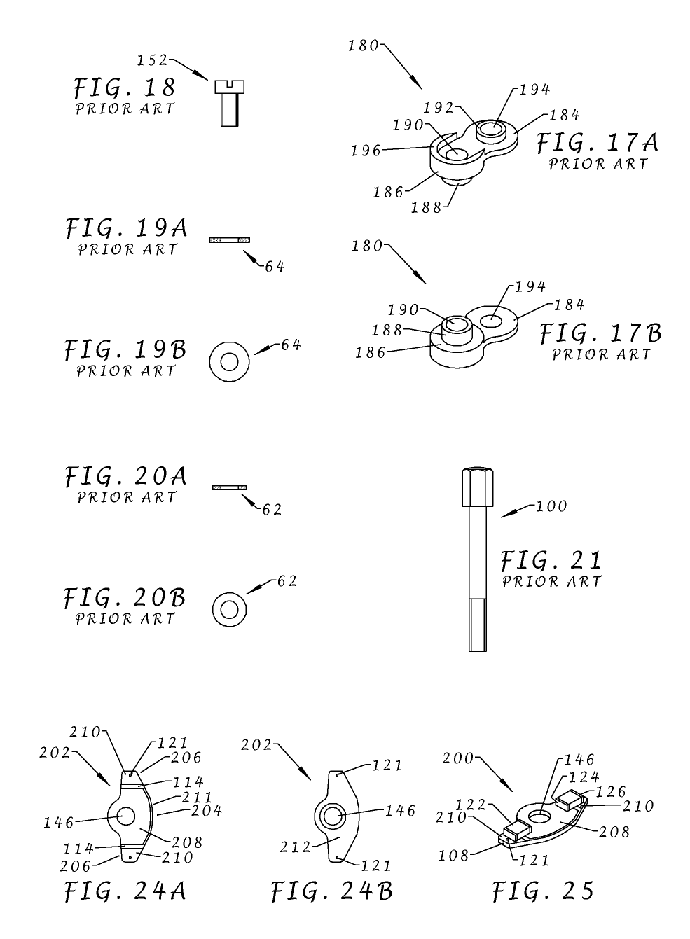

Referring now to FIGS. 14A to 21, a known later form of CB assembly for the K1F, K2F and KVF models of magneto, sometimes referred to as the “low inertia” CB assembly, comprises:
a steel back plate 150 (FIGS. 14A-C) with a tapered and keyed boss 102 on its underside, a central hole 84, a pivot post 94 and a screw-threaded hole 76 for receiving an assembly screw 152 (FIG. 18) provided with an insulating washer 64 (FIG. 19A-B) and a steel or brass washer 62 (FIGS. 20A-B).
a fixed CB point assembly 154 (FIGS. 15A-C) formed from two pieces 156,158 of stamped and bent steel sheet riveted together by a pair of rivets which also form a pair of fixed CB points 160. One of the pieces 156 has a hole 162 to fit the pivot post 94 of the back plate 150, and the other piece 158 has an arcuate slot 164 to receive the assembly screw 152. A central irregularly shaped hole 166 is formed between the two pieces 156,158.
a spring anchor bracket 168 (FIGS. 16A-C) formed from a piece of stamped and bent steel sheet. The anchor bracket 168 has a base portion 170 with a hole 172 to receive a centre screw 100 (FIG. 21) and a further hole 174 to receive the assembly screw 152. The anchor bracket 168 also has a pair of upturned ears 176 with screw threaded holes 178 therethrough.
an insulating block 180 (FIGS. 17A-B) of moulded nylon which will be described in more detail later.
moving point assembly (not shown) which has a body arranged to be pivotally mounted on the pivot post 94 of the back plate 34. The moving point assembly has a moving point for making electrical contact with one of the fixed points 160 (depending on which way round the moving point assembly is fitted to the pivot post 94), a follower heel for engaging with the ring cam 36, and a return leaf spring which is arranged to extend part way around the periphery of the back plate 150 from the body of the moving point assembly to one of the ears 176 of the anchor bracket 168 (depending on which way round the moving point assembly is fitted to the pivot post 94) where the spring can anchored by a screw engaging in the hole 178. The return spring serves to urge the moving point towards the fixed point 86 and also to make an electrical connection between the moving point and the anchor bracket 168.

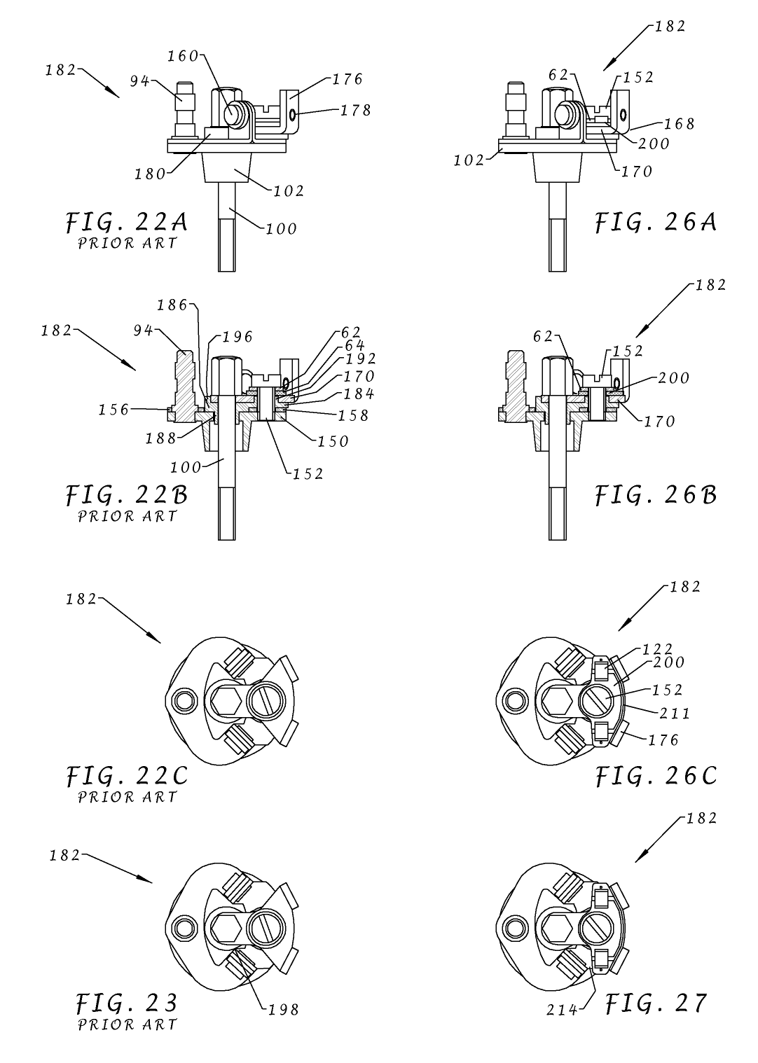

The assembled CB assembly 182 (apart from the moving point assembly) is shown in FIGS. 22A-C. The pieces 156,158 of the fixed point assembly 154 rest on the back plate 150, in electrical contact therewith, with the pivot post 94 engaged in the hole 162 in the piece 156 of the fixed point assembly 154. The insulating block 180 has a thin portion 184 which rests on the piece 158 of the fixed point assembly around the slot 164, and a thick portion 186 which passes through the central hole 166 in the fixed point assembly 154 and rests on the back plate 150. The thick portion 186 of the insulating block 180 has a boss 188 which extends into the central hole 84 in the back plate 150, and a hole 190 which passes centrally through the boss 188. The base 170 of the anchor bracket 168 rests on the insulating block 180. The block 180 has a further boss 192 which extends into the hole 174 in the anchor bracket 168, and a further hole 194 which passes centrally through the further boss 192. The insulating block 180 also has an upstanding lip 196 which partly surrounds the inner end of the base 170 of the anchor bracket 168 so as to centralise the hole 172 in the anchor bracket 168 with the holes 190,84 in the insulating block 180 and the back plate 150, respectively. The assembly screw 152 passes through the conductive washer 62, the insulating washer 64, the hole 194 in the insulating block 180 and the slot 164 in the piece 158 of the fixed CB point assembly 154 into engagement with the screw-threaded hole 76 in the back plate 150. The centre screw 100 passes through the hole 172 in the base 170 of the anchor bracket 168 and the hole 190 in the insulating block 180. When the CB assembly 182 is assembled with the magneto 10, the centre screw 100 engages with the centre nut (not shown, but previously described in connection with the early form of CB assembly 30) which is connected to the live end of the LT winding.

It will therefore be appreciated that, when the CB assembly 182 is assembled with the magneto 10, the live end of the LT winding is connected via the centre nut (not shown), the centre screw 100, the spring anchor bracket 168 and the return spring for the moving point assembly (not shown) to the moving point (not shown) which is therefore live. By contrast, the grounded end of the LT winding is connected via the body of the armature 14, the back plate 150 and the fixed CB point assembly 154 to whichever fixed point 160 is in use (depending on which way round the moving point assembly is fitted to the pivot post 94). It should also be noted that the assembly screw 152 is grounded due to its engagement in the screw-threaded hole 76 in the back plate 150, and is isolated from the live side of the CB assembly 182 by the boss 192 of the insulating block 180 and by the insulating washer 64. The upper face of the insulating washer 64 is in contact with the grounded brass or steel washer 62, whereas the lower face of the insulating washer 64 is in contact with the base 170 of the live spring anchor plate 168.

The points gap between the moving point (not shown) and whichever of the fixed points 160 is in use can be adjusted by slightly loosening the assembly screw 152, pivoting the fixed point assembly 154 about the pivot post 94 as necessary, and then re-tightening the assembly screw 152. FIG. 23 shows the limit in one direction of the adjustment of the fixed point assembly 154. In practice, the limit is not defined by the angular extent of the arcuate slot 164 in the fixed point assembly 154, but instead by collision of the fixed point assembly with the insulating block at the point referenced 198 in FIG. 23.

In the original configuration of the magneto 10 with the second form of CB assembly 182, the condenser 44 at the drive end of the armature 14 is connected between the ends of the LT winding. When the magneto 10 is converted for use with the fourth embodiment of the invention, the original condenser 44 is removed from the magneto 10 or electrically disconnected from the LT winding, and the insulating washer 64 is replaced by a condenser assembly 200 of the fourth embodiment of the invention, as will now be described with reference to FIGS. 24A-27.

### Fourth Embodiment of Condenser Assembly

As shown in FIGS. 24A-25, the condenser assembly 200 comprises a piece of PCB 202 having a substrate 108 of insulating material sandwiched between first and second outer copper layers. The PCB 202 has a central portion 204 and a pair of wing portions 206. The central portion 204 has a hole 146 to receive the screw 60. As shown in FIG. 24A, the first copper layer is etched to form furrows 114 between a central portion 208 and two tip portions 210 of the first copper layer so that each tip portion 210 is isolated from the central portion 208. Also, the central portion 208 of the first copper layer is etched so that it stops short of an arcuate side edge 211 of the PCB 202. As shown in FIG. 24B, the second copper layer 212 is etched so that it stops short of the central hole 146 through the PCB 202. The second copper layer 212 is electrically connected to each tip portion 210 of the first copper layer by one or more plated through-holes or vias 121. The PCB 202 may be manufactured using conventional PCB manufacturing techniques.

As shown in FIG. 25, the condenser assembly 200 also comprises two capacitors 122, each disposed so as to bridge a respective furrow 114 and connected between the central portion 208 and a respective tip portion 210 of the first copper layer of the PCB 202. Each capacitor 122 is of the multi-layer ceramic type in a surface mount package which is substantially cuboidal and has terminals 124,126 at a pair of opposite faces of the package. The terminals 124,126 are soldered to the PCB 202 using any conventional PCB soldering technique. The two capacitors 122 therefore become connected in parallel between the second copper layer 212 and the central portion 208 of the first copper layer.

As shown in FIGS. 26A-C, the condenser assembly 200 is mounted in the CB assembly 182 in place of the insulating washer 64, with the central portion 208 of the first copper layer contacting the brass or steel washer 62 under the head of the screw 152 and with the second copper layer 212 contacting the base 170 of the anchor bracket 168. The condenser assembly 200 therefore becomes electrically connected between the anchor bracket 168 and the back plate 102, and therefore between the fixed and moving points, and, when the CB assembly 182 is assembled with the remainder of the magneto 10, between the ends of the LT winding.

As shown in FIG. 26C, the arcuate side edge 211 of the PCB 202 abuts or stops slightly short of the upturned ears 176 of the live anchor bracket 168, so that the ears 176 can assist in correctly orienting the condenser assembly 200 in the CB assembly 182. However, the grounded central portion 208 of the first copper layer of the PCB 202 cannot make contact and short with the ears 176 because, as mentioned above, it is etched to stop short of the arcuate side edge 211. Also, the live second copper layer 212 cannot make contact and short with the grounded assembly screw 152 because, as mentioned above, it is etched to stop short of the central hole 146 through the PCB 202. As shown in FIG. 27, the wing portions 206 of the PCB 202 are sufficiently narrow that, when the fixed point assembly 154 is at its limits of adjustment, a gap 214 remains between the wing portions 206 of the PCB and the portions 216 of the fixed point assembly 154 on which the fixed points 160 are mounted.

Each capacitor 122 of the condenser assembly 200 may have a package size of 3.2×4.5×1.5 mm and a nominal capacitance of 68 nF (Murata part number GRM43QR72J683 KW01L) so that the nominal overall capacitance of the condenser assembly 200 is 136 nF.

It will be appreciated that many modifications and developments may be made to the embodiments of the invention described above. For example, the condenser assembly may be arranged to be clamped between other parts of the CB assemblies 30,182. In particular, the insulating block 180 (FIGS. 17A-B) used in the second form of CB assembly 182 may be replaced with a condenser assembly having portions of copper layer which make electrical contact with the fixed point assembly 154 and the anchor bracket 168.

It should be noted that the embodiments of the invention have been described above purely by way of example and that many other modifications and developments may be made thereto within the scope of the present invention.

1. An electrical condenser assembly for an automotive ignition system wherein the ignition system has first and second contact breaker points and first and second electrically conductive members electrically connected to the first and second contact breaker points, respectively, the first and second electrically conductive members having first and second faces, respectively, facing each other but not directly electrically connected to each other, the condenser assembly comprising:
an attachment portion arranged to be interposed between such first and second faces of such electrically conductive members of such an ignition system, the attachment portion having first and second oppositely facing electrically conductive faces for making electrical contact with the first and second faces, respectively, of the electrically conductive members of the ignition system, the first and second conductive faces of the attachment portion not being directly electrically connected to each other; and
at least one capacitor electrically connected to the first and second conductive faces of the attachment portion.

2. A condenser assembly as claimed in claim 1, wherein:
the attachment portion has a hole extending therethrough so that said first and second members of the ignition system can be mechanically connected through the hole, or so that one of said first and second members of the ignition system can pass through the hole.

3. A condenser assembly as claimed in claim 2, wherein:
the first and second faces of the of the attachment portion are provided by first and second substantially-coaxial, spaced-apart, annular members each having a respective hole therethrough;
the or each capacitor is disposed between the annular members; and
a passageway extends through the condenser assembly including through the holes of the annular members.

4. A condenser assembly as claimed in claim 3, wherein:
there is a plurality of such capacitors arranged around the axis of the annular members.

5. A condenser assembly as claimed in claim 4, wherein:
interstices between the capacitors and around the passageway are filled with an electrically insulating material.

6. A condenser assembly as claimed in claim 3, wherein:
the or each capacitor has a substantially cuboidal package with terminals at a pair of opposed ends of the package; and
each terminal faces and is electrically connected to a respective one of the annular members.

7. A condenser assembly as claimed in claim 1, wherein:
the attachment portion is provided by a region of board having a substrate of electrically insulating material sandwiched between first and second outer layers of electrically conductive material; and
respective portions of the first and second layers provide the first and second electrically conductive faces of the attachment portion.

8. A condenser assembly as claimed in claim 7, wherein:
the board also provides at least one capacitor mounting region in which the capacitor(s) is/are mounted.

9. A condenser assembly as claimed in claim 8, wherein:
the capacitor or at least one of the capacitors is electrically connected between first and second portions of one of the layers in that capacitor's mounting region;
the first portion of that layer is contiguous with the portion of that layer in the attachment region; and
the second portion of that layer is electrically connected to the portion of the other layer in the attachment region; and
the first and second portions are not directly electrically connected to each other.

10. A condenser assembly as claimed in claim 9, wherein:
in the or each capacitor mounting region, the first and second portions are separated by a furrow in the board; and
the or each capacitor bridges the furrow.

11. A magneto having:
a low tension coil;
a contact breaker assembly having:
first and second contact breaker points electrically connected in parallel with the low tension coil and;
first and second electrically conductive members electrically connected to the first and second contact breaker points, respectively, the first and second electrically conductive members having first and second faces, respectively, facing each other but not directly electrically connected to each other; and
a condenser assembly comprising:
an attachment portion interposed between the first and second faces of the electrically conductive members of the contact breaker assembly, the attachment portion having first and second oppositely facing electrically conductive faces making electrical contact with the first and second faces, respectively, of the electrically conductive members of the contact breaker assembly, the first and second conductive faces of the attachment portion not being directly electrically connected to each other; and
at least one capacitor electrically connected to the first and second conductive faces of the attachment portion.

12. A magneto as claimed in claim 11, wherein:
the magneto has a rotatable armature;
the low tension coil and contact breaker assembly are mounted for rotation with the armature; and
the condenser assembly is mounted on the contact breaker assembly.

13. A magneto as claimed in claim 12, wherein:
the armature is mounted for rotation by a pair of spaced-apart bearings;
the low tension coil is disposed between the bearings; and
the contact breaker assembly is mounted at one end of the armature beyond the bearings.

14. A method of modification of a magneto having an armature with a low-tension winding and a condenser electrically connected in parallel with each other and disposed between a drive-end end-piece and a tail-end end-piece of the armature, and a contact breaker assembly mounted on the tail-end end-piece and having first and second contact breaker points electrically connected in parallel with the low tension winding and first and second electrically conductive members electrically connected to the first and second contact breaker points, respectively, the first and second electrically conductive members having first and second faces, respectively, facing each other but not directly electrically connected to each other, the method comprising the steps of:
rendering the condenser substantially ineffective on the low-tension winding;
providing a condenser assembly comprising:
an attachment portion having first and second oppositely facing electrically conductive faces which are not directly electrically connected to each other; and
at least one capacitor electrically connected to the first and second conductive faces of the attachment portion; and
fitting the condenser assembly to the contact breaker assembly so that:
the attachment portion is interposed between the first and second faces of the electrically conductive members of the contact breaker assembly; and
the first and second faces of the attachment portion make electrical contact with the first and second faces, respectively, of the electrically conductive members of the contact breaker assembly;
whereby the capacitor(s) of the condenser assembly is/are electrically connected in parallel with the low-tension winding.
